(19) United States
(12) Patent Application Publication
(10) Pub. No.: US 2009/0131562 A1
(43) Pub. Date: May 21, 2009

(54) Water soluble anionic polymers compositions for resisting erosion

(76) Inventor: Naresh Kanderi, Chesapeake, VA (US)

Correspondence Address: JoAnn Villamizar;Ciba Corporation/Patent Department, 540 White Plains Road, P.O. Box 2005, Tarrytown, NY, 10591, US

(21) Appl. No.: 12/291,243

(22) Filed: Nov. 7, 2008

Related U.S. Application Data
(60) Provisional application No. 61/002,541, filed on Nov. 9, 2007.

(51) Int. Cl. C08L 97/02

(52) U.S. Cl. 524/14; 524/16

(57) ABSTRACT

The present invention encompasses hydroseeding aqueous compositions comprising anionic water soluble polymers and organic materials such as cellulose, mulch and/or seed. The anionic polymeric materials are very lightly crosslinked thus giving anionic polymers which are substantially water soluble. The aqueous compositions may be may be applied to soil surfaces which compositions provide an improved soil protective layer from wind and water erosion.

The application claims the benefit of U.S. Provisional Ser. No. 61/002,541 filed on Nov. 9, 2007 herein incorporated entirely by reference.

### FIELD OF THE INVENTION

The present invention is directed to mulching, hydroseeding or hydro-mulching aqueous compositions comprising anionic water soluble polymers and organic materials such as cellulose, mulch and/or seed. The anionic polymeric materials are lightly crosslinked, branched or structured thus giving anionic polymers which are substantially water soluble. The aqueous compositions may be applied to soil surfaces which compositions provide an improved soil protective layer from wind and water erosion.

### BACKGROUND

It is well known that erosion occurs via wind and water which in turn remove topsoil from one place to another. It is also well known that polyacrylamide can reduce soil erosion by preventing water from carrying away soil particles as the water flows down a furrow or incline.

It is also well known to use anionic polyacrylamide for soil erosion control. For example, SOILFIX IR and SOILFIX LDP, are linear anionic copolymers of acrylamide and sodium acrylate and are available from Ciba Corporation for soil erosion control and water infiltration applications on irrigated soils and surface irrigated crops.

The coating of soils with agricultural mulch is also well known in the art. For example, U.S. Pat. Nos. 3,812,615 and 4,297,810 disclose mulch compositions which comprise such organic matter as hay, peat, peat moss, wood chips, chopped bark, saw dust, straw, ground corn, barley hulls etc in combination with a binder like gum.

Furthermore, U.S. Pat. Nos. 6,562,882 and 6,835,761, herein incorporated entirely by reference, disclose soil erosion compositions comprising linear anionic polyacrylamide and mulch.

Such products, however, are of limited effectiveness and may not provide the degree of soil erosion resistance as may be desired. For example, severe rain and wind conditions may easily remove anionic polyacrylamide and mulch compositions. Thus there is a need for improved mulch compositions that are effective under sever weather conditions. Furthermore, there is a need for compositions which are easily mixed and applied using standard equipment to achieve uniform coverage of land areas. Additionally, more efficient mulch compositions are desired which may be applied at lower levels but achieve similar or better performance.

The inventor has surprisingly discovered that lightly crosslinked, branched or structured anionic polyacrylamide when combined with mulch offers just such advantages.

### SUMMARY OF THE INVENTION

Thus the invention encompasses a soil erosion resistant admixture which admixture comprises
a) a branched water-soluble polymer formed from acrylamide and an anionic monomer or hydrolyzed poly acrylamide
   and a branching agent,
   wherein the branching agent is used in an amount of from 1 to 30 ppm, preferably 1 to 20 ppm and most preferably 1 to 10 ppm,
and
b) mulch.

The invention also encompasses a soil erosion resistant admixture which admixture comprises

a) a structured water-soluble polymer formed from acrylamide and an anionic monomer or a hydrolyzed polyacrylamide,
wherein the structured water-soluble polymer is formed in the presence of a diblock or triblock copolymer based on polyester derivatives of fatty acids
   and
   b) mulch.

The admixture above is combined with water or water is combined with the admixture before applying to an erodible soil surface. The aqueous admixture is then sprayed or applied to a soil surface to prevent and protect the surface from wind and water erosion.

Thus the invention also encompasses a method for reducing erosion of a soil surface by combining the admixtures above with water

and
applying to said surface.

The invention also encompasses a mat like structure overlaying a soil area which structure is formed from the admixture described above when the weight of the mulch is at least 2000 lbs/acre and the polymer is at least about 1.5 wt. % of the mulch.

Pounds/acre is based on dry weight of the mulch. Weight % of polymer is also based on the dry weight of the polymer and dry weight of the mulch. In practice the mulch will almost always contain some water. Thus when the applicant refer to the dry weight of the mulch what is meant is the weight of the mulch as supplied which is essentially dry.

Furthermore, the invention envisions a method for reducing erosion from a soil surface by treating said surface with a
branched water-soluble polymer formed from acrylamide and an anionic monomer or hydrolyzed polyacrylamide
and a
branching agent,
wherein the branching agent is used in an amount from 1 to 30 ppm, preferably 1 to 20 ppm and most preferably 1 to 10 ppm.

Or alternatively the invention is also directed to a method of treating a solil surface with

a) a structured water-soluble polymer formed from acrylamide and an anionic monomer or a hydrolyzed polyacrylamide,
wherein the structured water-soluble polymer is formed in the presence of a diblock or triblock copolymer based on polyester derivatives of fatty acids.

Additionally, a soil erosion resistant admixture is envisioned which admixture comprises a branched, structured or lightly crosslinked polymer formed from acrylamide, anionic monomer, wherein the branched, structured or lightly crosslinked polymer has an intrinsic viscosity of at least about 3 dl/g.

### DETAILED DESCRIPTION OF THE INVENTION

Percent for purposes of the invention means weight percent unless otherwise specified.

The polymer formed from acrylamide and anionic monomer will most typically be a copolymer formed from acrylamide and (meth) acrylic acid.

But alternatively, the anionic monomer may be selected from the group consisting of the free acids and salts of acrylic acid, methacrylic acid, maleic acid, itaconic acid, 2-acrylamido-2-methyl-1-propanesulfonic acid and mixtures thereof.

It is also possible that the water-soluble anionic polymer be formed from in addition to acrylamide other non-ionic monomers and/or cationic monomers.

For example, while the water-soluble anionic polymer will be formed from at least acrylamide, it may also be formed from additional non-ionic monomers and more than one anionic monomer.

Additional non-ionic monomers may include for example, methacrylamide, N-alkylacrylamides, such as N-methylacrylamide and N,N-dialkylacrylamide, such as N,N-dimethylacrylamide.

Cationic monomers (or potentially cationic monomers) would include for example may be dialkylaminoalkyl(meth)acrylates, quaternized dialkylaminoalkyl(meth)acrylates, dialkylaminoalkyl(meth)acrylate acid salts and diallyl quaternary ammonium salts.

Representative examples may include dimethylaminoethyl acrylate methyl chloride quaternary salt, dimethylaminoethyl methacrylate methyl chloride quaternary salt, diethylaminoethyl acrylate, diethylaminoethyl acrylate methyl chloride quaternary salt, diethylaminoethyl methacrylate, diethylaminoethyl methacrylate methyl chloride quaternary salt and diallyldimethyl ammonium chloride.

Branched for purposes of the invention means the polymer formed from acrylamide and (meth)acrylic acid, salts thereof or hydrolyzed polyacrylamide has structure imparted to the polymer. Structure may be imparted via a crosslinking or branching agent. Polymeric structure may also be imparted via certain surfactants such as diblock and triblock polymeric surfactants described in U.S. Pat. No. 7,250,448, herein incorporated entirely by reference.

Because the branching agent is used at low concentrations, the branching agent may be effective in increasing the molecular weight and giving structure to the polymer but the branched polymer formed remains essentially water soluble.

For purposes of the invention the terms “branched polymer” “structured polymer” and “lightly crosslinked” may be used interchangeably.

The term mulch encompasses organic material such as cellulose fibers, mulch, seed, hay, wood chips, peat, peat moss, chopped bark, saw dust, straw, ground corn, barley hulls, shredded waste newsprint and mixtures thereof.

The seeds may include tree, grass, vine bush or combinations thereof which may establish vegetation growth.

Water soluble for purposes of the invention means that the polymer is substantially soluble in water and does not form a microbead or microparticulate.

The water soluble polymer is preferably formed from water soluble monomers. The branched polymer or structured polymer used in the admixture may be formed as described in U.S. Pat. Nos. 6,310,157, 7,250,448 herein incorporated entirely by reference.

Furthermore, the polymer may be prepared by reacting the monomer or monomer blend under polymerization conditions in conventional manner except that the branching agent is included in the monomer charge. The amount of branching agent and the polymerization conditions under which the monomer charge is reacted to form the polymer are selected in such a manner that the polymer is a water soluble branched, structured or lightly crosslinked polymer and is not a water insoluble cross linked polymer.

In particular, if the polymer is made by reverse phase emulsion polymerization and is highly cross linked (and thus includes water insoluble particles) instead of being branched and water soluble (as in the invention), the polymer will behave as a particulate or microbead polymer in an aqueous suspension instead of behaving as a true solution polymer. This is undesirable for purposes of the invention.

It is important that the amount of branching agent is kept to very low values. If the amount is less than about 0.5 to 1 ppm, based on the total monomer charge, then the desired improved formation will not be achieved. If the amount is too high, then the desired improvement in soil erosion control and pumpability will not be achieved. For instance, if the amount is too high then the anionic polymer will behave as an insoluble cross linked microparticulate polymer instead of behaving as a water soluble branched polymer which lightly branched polymer gives improved soil erosion protection when combined with mulch.

The precise amount of branching agent that is used in the production of the anionic polyacrylamide depends on the particular branching agent which is being used and on the polymerization conditions which are being used. In particular, as mentioned below, it is possible to add chain transfer agent in which event the amount of branching agent which is used may be higher than the amount which would be used in the absence of chain transfer agent.

The branching agent can be a branching agent that causes branching by reaction through carboxylic or other pendant groups (for instance an epoxide, silane, polyvalent metal or formaldehyde) but preferably the branching agent is an ethylenically unsaturated compound which is included in the monomer blend from which the polymer is formed. The branching agent may be monofunctional or a difunctional material such as methylene bis acrylamide, or it can be a trifunctional, tetrafunctional or higher functional branching agent, for instance tetra allyl ammonium chloride or mixtures thereof. Preferably the branching agent is water soluble.

The anionic polymer may be formed first then the polymer may be reacted with the branching agent. In other words, it is not required for the branching agent to be present during formation of the anionic polymer.

Generally since allylic monomers tend to have lower reactivity ratios, they polymerize less readily and thus it is standard practice when using polyethylenically unsaturated allylic branching agents, such as tetra allyl ammonium chloride to use higher levels, for instance 5 to 30 or even 35 molar ppm or even 38 ppm and even as much as 70 or 100 ppm.

The amount of the branching agent is generally below 10 ppm and most preferably below 5 ppm. Best results may be obtained with around 0.5 to 3 or 3.5 ppm or 3.8 ppm but in some instances amounts above 4.1 or 4.2 ppm up to 7 or even 10 ppm or higher are appropriate. Thus sometimes amounts up to 20 ppm are useful, or even up to 30 or 40 ppm (generally in the presence of chain transfer agent) but lower amounts are typically used. Unless otherwise stated, throughout this specification the amount of branching agent is quoted as moles branching agent per million moles monomer (i.e., ppm molar).

For example, an amount from about 1 to 30 ppm branching agent may be used in the presence of a chain transfer agent or when the branching agent is polyethylenically unsaturated allylic branching agent, about 1 to 20 ppm may be used in the absence of a chain transfer agent and most preferably 1 to 10 ppm of branching agent may be used when the branching agent is methylene bis acrylamide and no chain transfer agent is present during the polymerization.

A chain transfer agent may or may not be present during polymerization.

The branched polymer of the invention may be made under polymerization conditions wherein it is intended that there should be no deliberate chain transfer agent present during the reaction. The amounts of branching agent quoted above (for instance 1 to 10 ppm and preferably 1 to 3.8 ppm) are particularly suitable when no chain transfer agent is added. However it can be desirable to add some chain transfer agent in which event it is possible to increase the amount of branching agent up to 20 or 30 ppm or 40 ppm, and while still maintaining the characteristic properties and performance of the polymer. The amount of chain transfer agent which is selected will depend upon the particular material which is being used and upon the amount of branching agent, the monomer charge, and the polymerization conditions.

Although quite large amounts of branching agent can be used, preferably the amount is quite low since it seems that best results are obtained with the use of low amounts of chain transfer agent.

A preferred chain transfer agent is sodium hypophosphite. Although large amounts can be used best results generally require amounts for the chain transfer agent of below 50 ppm and preferably below 20 ppm (by weight based on the weight of monomer). Best results are generally obtained with not more than 10 ppm. However if the amount is too low, for instance below about 2 ppm, there may be inadequate benefit from using a chain transfer agent.

Thus the chain transfer agent amount used may vary from about 2 ppm (based on monomer weight) to about 50 ppm, about 5 ppm to about 20 ppm or about 5 ppm to about 10 ppm chain transfer agent.

Any of the chain transfer agents which are suitable for use as chain transfer agents in the aqueous polymerization of water soluble (meth)acrylic monomers (such as isopropanol or mercapto compounds) can be used in the invention as an alternative to the preferred material, hypophosphite. If a material other than hypophosphite is being used, it should be used in an amount selected so that it gives substantially the same chain transfer effect as the quoted amounts for hypophosphite.

Structure may be given to an anionic polymer by forming the anionic polymer in the presence of a certain surfactants such as diblock and triblock polymeric surfactants described in U.S. Pat. No. 7,250,448 and herein incorporated entirely by reference.

The diblock and triblock polymeric surfactants may include for example diblock and triblock copolymers which are based on polyester derivatives of fatty acids and poly[ethyleneoxide]. Specific examples are fatty acids esters of polyethyleneoxide such as HYPERMER B246SF and IL-2595 commercially available from Uniqema.

The anionic polyacrylamide polymer will normally have an intrinsic viscosity of at least 3 dl/g. It is usually at least 3 or 4 dl/g, and preferably at least 6 dl/g. It can be as high as, for instance, 18 dl/g but is usually below 12 dl/g and often below 10 dl/g.

As well known in the art, anionic polyacrylamide polymer may be formed from a homopolymer of polyacrylamide which has been hydrolyzed to achieve an anionic charge. This hydrolyzed polymer may be treated with a branching agent to arrive at a lightly branched anionic polyacrylamide.

The intrinsic viscosity (IV) is measured using a suspended level viscometer in 1M NaCl buffered to pH 7.5 at 25° C.

Intrinsic viscosity (IV) is one of the characteristics that distinguished a lightly crosslinked, branched or structured polymer from a linear or highly crosslinked polymer of the same average molecular weight and monomer make-up. For example, the branched, lightly cross-linked or structured polymer used in the hydroseeding compositions of the invention will typically have an IV of at least about 3 dl/g or at least 4 dl/g. The upper limit for the IV for a lightly cross linked, structured or branched polymer of the same average molecular weight and monomer makeup would for example be a maximum of about 12 dl/g.

Thus the IV of the lightly crosslinked branched polymer may range from about 3 dl/g to about 10 or 12 dl/g.

Highly crosslinked polymers of the same average molecular weight will give polymers of very low IV, usually less than about 2 dl/g or 1 dl/g.

In contrast, linear polymers of the same average molecular weight and monomer make up will typically have very high IV values such as 13 dl/g and above. More typically the linear polymer may have an IV as high as about 18 to about 30 dl/g.

### Method of Preparing the Anionic Polymer

The polymers of the invention can be made by any of the conventional suitable polymerization processes which are known for making water soluble (meth)acrylic and other addition polymers such as bead or gel polymerizations. The preferred type of polymerization process is reverse phase emulsion polymerization so as to form a reverse phase emulsion of water soluble polymer particles in non-aqueous liquid. This product typically has an initial particle size at least 95% by weight below 10 μm and preferably at least 90% by weight below 2 μm, for instance down to 0.1 or 0.5 μm. It can therefore be a conventional reverse phase emulsion or microemulsion and can be made by any of the known techniques for making such materials. Satisfactory results may be e obtained with particles above 1 μm.

The emulsion can be supplied in the form in which it is made (as an emulsion of aqueous polymer droplets in oil or other water immiscible liquid) or if desired it can be substantially dehydrated to form a stable dispersion of substantially anhydrous polymer droplets dispersed in oil. Conventional surfactant and optional polymeric amphipathic stabilizer may be included in known manner to stabilize the emulsion.

The reverse phase or other polymerization process is conducted on a charge of the desired monomer or monomer blend. The monomer or monomer blend which serves as the charge for the polymerization is usually an aqueous solution.

It is generally preferred for the anionic branched polymer to be a polymer of 90 to 10% by weight acrylamide monomer and 10 to 90% by weight ethylenically unsaturated carboxylic anionic monomer. Any of the conventional water soluble carboxylic acid monomers may be used such as acrylic acid and methacrylic acid. The preferred anionic monomer is often acrylic acid, often introduced as sodium acrylate or other water soluble salt. The water soluble polymers contain from about 20 to about 80%, often about 30 to about 75%, also 35 to about 70 by weight acrylic acid (often as sodium acrylate) with the balance being acrylamide.

For example, the branched water-soluble polymer is formed from a weight ratio of acrylamide:acrylic acid that may range from about 10:90 to 90:10, about 20:80 to about 80:20 or about 30:70 to about 70:30.

Initiator is added to the charge in an amount and under conditions, and the charge is maintained at a temperature, such that the corresponding unbranched polymer would have whatever IV is appropriate having regard to the properties which are required and the amount of branching agent and possibly chain transfer agent.

Activating surfactant may be added to the polymer emulsion in order to promote the equilibration or activation of the emulsion into water.

The admixture (mulch and polymer) may comprise compositions for example wherein the polymer makes up at least about 0.10 weight % of the admixture based on the total dry weight of the mulch. The polymer make-up of the admixture may vary anywhere from about 0.10 wt. % to about 5 wt. % but more typically the weight ratio of polymer to mulch will vary from about 0.20 to about 5 wt. % or about 0.20 to about 1.25 wt. %.

At levels of application of about 2 wt. % polymer and above, the mulch mixture upon drying creates a mat like structure overlaying the soil. For example, when applications of mulch are about 2200 lbs/acre and the wt. % of the polymer exceeds 1.5%, then the applied dried mixture forms a mat like structure with high strength.

It is very difficult to apply a linear polymer mulch mixtures at application levels above 1.1 wt. % because the mixtures are excessively viscous and thus difficult to pump.

The present lightly branched polymer may be combined with mulch at levels of 1.5 to 5 wt. % or 2 to about 5 wt % forming a mat like structured appearance over the treated soil area. This mat like structure may offer an alternative to the more costly blanket or netting structures used for soil stabilization.

Other ingredients may optionally be added to the admixture in addition to the mulch and the anionic polymer such as fertilizers, herbicides and pesticides.

While not wishing to be bound by any theory, it is believed that the lightly crosslinked, branched or structured polymer may form a high strength matrix due to the lightly structured nature of polymer molecule thereby entrapping mulch at various points.

The lightly branched, structured or crosslinked polymer does not appear to hydrate immediately compared to the linear polymer of the same charge. As there is this lag in hydration of the lightly branched/crosslinked or structured polymer, the polymer does not get sheared by the hydroseeding mixture and pumps. However after spraying, the lightly structured polymer continues to uncoil in situ and in the process entrap the mulch and soil particles at various points thereby forming a more structured ground covering matrix which shows superior rain withstanding characteristics.

Light structuring or branching of the polymer enhances the chain length through the branching agent. If the cross linking or branching is too much, the chain length reduces by forming a net like structure which acts like an insoluble superabsorbent. Thus the invention (combination of mulch with lightly crosslinked polymer) has managed to give improved performance as compared to the linear polymer without making the branched/crosslinked polymer into a superabsorbent.

The method for reducing erosion from a soil surface calls for combining the admixture (mulch and polymer) with water and applying to said soil surface.

It is also possible to reduce erosion from a soil surface by use of the lightly branched polymer only.

Thus a method for reducing erosion from a soil surface is encompassed by the invention by treating the soil surface with the lightly branched polymer described above. The lightly branched polymer may be combined with water to facilitate the efficient spreading of the branched polymer over the soil.

The admixture will normally be mixed with water in order to conveniently apply to a soil surface. To that end, the water may be added in the amount of one and one-half to six gallons per pound of polymer/mulch material.

The combining of the admixture with water may be done in virtually any order. For example, the mulch may be added to the water, then the polymer may be mixed with the water mulch mixture. Alternatively, the mulch and polymer may be added simultaneously or separately to the water. It is also possible to add the water to either the mulch and/or polymer.

Furthermore, application of the mulch/polymer mixture or polymer alone may be carried out on a sloping, flat or variable soil surface.

Generally a minimum application will include about five hundred pounds of polymer/mulch mixed with about three thousand gallons of water for distribution per acre. If a maximum amount of soil erosion protection is desired as much as one tone of polymer/mulch per three thousand gallons of water will be applied per half acre.

The amount of mulch/polymer application will vary and depend on the potential of the land surface for erosion, the slope of the land, the makeup of the soil itself and the season of application.

For applications in which the polymer alone (without mulch), the polymer use levels may range from about 1 pound per acre to about 500 pounds per acre. The coverage is, for example, about 10 pounds per acre to about 100 pounds per acre. For example, the coverage rate may be about 10 pounds per acre to about 50 pounds per acre.

### EXAMPLE 1

A branched polymer A is formed by reverse phase emulsion polymerization in conventional manner from 40% by weight sodium acrylate and 60% by weight acrylamide and 3.5 ppm of methylene bis acrylamide (as moles branching agent per million moles monomer) in the absence of chain transfer agent. The resultant emulsion is subjected to azeotropic distillation to form a stable dispersion of substantially anhydrous polymer droplets, 98% having a size of <1 μm, dispersed in oil. The resulting branched polymer has an IV of 9-11 dl/g

### EXAMPLE 2

Polymer B is a highly crosslinked (60% crosslinked) anionic polymer formed from acrylamide and acrylic acid in a 60:40 weight ratio. The polymer is formed by reverse phase polymerization to give an emulsion as in example 1 but without azeotropic removal of water. The polymerization of acrylamide and acrylic acid is done in the presence of 40 ppm (as moles branching agent per million moles monomer) melthylenebisacrylamide. The crosslinked anionic polymer has IV of about 1 dl/g.

### EXAMPLE 3

Polymer C is a linear anionic polymer formed from acrylamide and acrylic acid in a 60:40 weight ratio. No branching agent is used in the formation of this polymer. The polymer is formed by reverse phase polymerization as in example 1. The resulting polymer has an IV of about 18 dl/g.

### Application Examples

TABLE 1
Laboratory Testing with Mulch

| | | Wt. Ratio of polymer:mulch |
|---|---|---|
| Test | Mulch Rate (grams) | (%) |
| 1 | 10 | 0.50 |
| 2 | 10 | 2.00 |

The three different polymers A, B and C from examples 1, 2 and 3 were combined separately with mulch and water to give 150 grams aqueous solution at 0.5 wt. % and 2.0 wt. %. Thus in all, 6 sets of mulch and polymers are mixed and observed for blendability, slickness and general feel.

TABLE 2
Qualitative Observations of Mulch Blends

| Blend | 0.5 wt. % polymer | 2.0 wt. % polymer |
|---|---|---|
| Mulch + polymer A | Blending of all | Blending of all |
| | ingredients giving a | ingredients gives |
| | slick homogenous | homogenous |
| | solution. | solution |
| Mulch + polymer B | Did not viscosify | Did not viscosify |
| Mulch + polymer C | Clear and colorless | ¹Clear and |
| | solution | colorless solution |

¹At 2.0% the linear polymer C is evident in the mulch mix but the mixture never forms into a slick homogenous solution at 0.5%. The solution mixture remains colorless.

Ideally, a seemingly homogenous mixture is desired. By homogenous mixture, it is meant that the mixture of mulch and polymer is evenly distributed throughout the hydroseeding composition. As is seen in the qualitative observations above, the combination of polymer A with mulch (invention) gives an aqueous matrix in which mulch and polymer are bound even at lower polymer concentration. This is less evident in the mulch polymer B and C combinations.

TABLE 3
Florida Field Tests in Hydroseeding Machine

| | Mulch Rate | Wt. Ratio of polymer:mulch |
|---|---|---|
| Test | (lbs/acre) | (%) |
| 3 | 2200 | 1.1 to 2.93 |
| 4 | 3300 | 1.1 to 2.93 |

Both polymers A (lightly crosslinked) and D (linear) are tested in a hydroseeding machine at varying levels from 1.1 to 2.93 wt. % polymer. Enough water is added to create a sprayable slurry.

Polymer D is a linear anionic polymer formed from acrylamide and acrylic acid in a 64:36 weight ratio, No branching agent is used in the formation of this polymer. The polymer is formed by reverse phase polymerization as in example 1 but without azeotropic removal of water. The resulting polymer has a typical IV of about 27 dl/g, but can vary. Polymer D was selected as this linear polymer is used widely and successfully in hydroseeding.

Thus the lightly crosslinked polymer is compared to the best linear polymer in the industry.

Polymer A is blended with mulch in the hydroseeding tank without any indication of lumps or fish eyes. As the weight ratio of polymer A is increased from 1.1 to 2.93 wt. % (wt. ratio to mulch), the slurry remains pumpable and easily sprayable.

The mulch mixture of polymer D is pumpable at only the lower wt. ratio of 1.1 wt. %. An attempt is made to increase the amount of polymer D to 2.93 wt. % in a small bucket but is unsuccessful as the mulch mixture becomes too viscous for use in the hydroseeding machine.

The mulch/polymer aqueous compositions are field tested. Increased polymer content (2.93 wt. % and polymer A with mulch) sprayed on plots of land via hydroseeding machine show better strength and structure by forming a mat like polymer bound/mulch matrix/semi hard film which after drying when pulled on appears to retain its bound mulch structure. This formation of a mat like structure is a distinct advantage of optimized polymer levels and may replace more costly soil stabilizing products such as mats and blankets.

The polymer D with mulch as noted above could not be added at the higher wt. % because the resulting mixture appeared to not be pumpable. Thus the linear polymer with mulch does not form a mat like polymer bound/mulch matrix on soil because the linear polymer cannot be added at the higher levels.

TABLE 4
Testing of Mulch/Polymer under Rain Conditions

| | Mulch Rate | Wt. Ratio of polymer:mulch |
|---|---|---|
| Test | (lbs/acre) | (%) |
| 4 | 2200 | 0.25 |
| 5 | 3300 | 0.75 |

Polymers A (lightly crosslinked), B (highly crosslinked) and D (linear) are combined with mulch at the above 0.25 and 0.75 wt. %. Enough water is added to create a sprayable slurry. Thus three sets of mulch @2200 lbs/acre and 3 sets of mulch @3300 lbs/acre are sprayed onto individual plots and allowed to dry for 24 hours. In total, 6 mulch patches are tested under artificial rain conditions.

### Rainfall Simulator

A rainfall simulator is used to test the 6 mulch/polymer treated plots. The rain fall rate is 6 inches/hour, simulating severe rain conditions.

The plots are then monitored to determine the length of time it takes to reduce the retained mulch i.e. how many minutes 80% of the mulch remains intact. The results are below in Table 5.

Artificial rain is simulated by an overhead sprinkler system attached to a steady water supply under constant pressure and temperature. The existing water from the sprinkler is collected into a measurable basin where the inches of artificial rain is quantified over time. All the rain watering of the test plots is carried out at the same pressure and temperature and thus artificial rain rate across the experimental plots is made similar and directly comparable.

TABLE 5
Rain Simulation Results for 2200 lbs/acre
Mulch and 0.25 wt. % Polymer

| | Time |
|---|---|
| Polymer | (minutes) |
| Polymer A | >7 minutes |
| Polymer B | <2 minutes |
| Polymer C | <3 minutes |

The rain simulation results for the 3300 lbs/acre at 0.75 wt. % polymer applications show the same trend.

Based on all the above tests the lightly structured polymer in combination with the mulch is found to offer the following properties,
viscosity reducing friction thereby enabling better hydroseeding spray and distance;
semi hard film forming tendency by binding better;
and better rain withstanding capability.

We claim:

1. A soil erosion resistant admixture which admixture comprises
c) a branched water-soluble polymer formed from acrylamide, anionic monomer and a branching agent,
wherein the branching agent is used in an amount of from 1 to 30 ppm,
and
d) mulch.

2. The admixture according to claim 1, wherein the branching agent is monofunctional, difunctional, trifunctional, tetrafunctional or higher functional branching agent.

3. The admixture according to claim 1, wherein the branching agent is at least difunctional and is methylene bis acrylamide, tetra allyl ammonium chloride or mixtures thereof.

4. The admixture according to claim 1, wherein the branching agent is methylene bis acrylamide.

5. The admixture according to claim 4, wherein the methylene bis acrylamide is used in an amount of 1 to 10 ppm.

6. The admixture according to claim 1, wherein the branched water-soluble polymer has an intrinsic viscosity of at least about 3 dl/g.

7. The admixture according to claim 1, wherein the branched water-soluble polymer is formed from a weight ratio of acrylamide:acrylic acid that ranges from about 10:90 to 90:10.

8. The admixture according to claim 1, wherein the mulch is an
organic material selected from the group consisting of cellulose fibers, mulch, seed, hay, wood chips, peat, peat moss, chopped bark, saw dust, straw, ground corn, barley hulls, shredded waste newsprint and mixtures thereof.

9. The admixture according to claim 1 wherein the water soluble polymer is formed in the presence of a chain transfer agent.

10. The admixture according to claim 1, wherein the water soluble polymer is formed in the absence of a chain transfer agent.

11. The admixture according to claim 1, wherein the water soluble polymer is made by conventional reverse phase emulsion polymerization and then the emulsion is substantially dehydrated to form a stable dispersion of substantially anhydrous polymer droplets dispersed in oil.

12. The admixture according to claim 1, wherein the polymer is at least about 0.10 wt. % based on the total dry weight of the mulch.

13. The admixture according to claim 1, wherein the polymer varies from about 0.20 to about 5 wt. % of the total dry weight of the mulch.

14. A method for reducing erosion of a soil surface by
combining the admixture according to claim 1 with water
and
applying to said surface.

15. A method according to claim 14, wherein the polymer is about 0.10 to about 5 wt. % of the dry weight of the mulch.

16. A mat like structure overlaying a soil area which structure is formed from the admixture according to claim 1, the weight of the mulch is at least 2000 lbs/acre and the polymer is at least 1.5 wt. % of the mulch.

17. A method for reducing erosion from a soil surface by treating said surface with a branched water-soluble polymer formed from acrylamide and acrylic acid or hydrolyzed polyacrylamide and a
branching agent,
wherein the branching agent is used in an amount from 1 to 30 ppm.

18. A soil erosion resistant admixture which admixture comprises
a) a structured water-soluble polymer formed from acrylamide and an anionic monomer or a hydrolyzed polyacrylamide,
wherein the structured water-soluble polymer is formed in the presence of a diblock or triblock copolymer based on polyester derivatives of fatty acids;
and
b) mulch.

19. A soil erosion resistant admixture which admixture comprises
a branched, structured or lightly crosslinked polymer formed from acrylamide and an anionic monomer, wherein the formed branched, structured or lightly crosslinked polymer has an intrinsic viscosity of at least about 3 dl/g
and
mulch.
